(19) United States
(12) Patent Application Publication
(10) Pub. No.: US 2007/0106725 A1
(43) Pub. Date: May 10, 2007

(54) Methods, systems, and computer program products for providing a scheduler for multiple parties

(76) Inventors: Robert Starr, Decatur, GA (US); Jerry Liu, Atlanta, GA (US)

Correspondence Address: CANTOR COLBURN LLP - BELLSOUTH, 55 GRIFFIN ROAD SOUTH, BLOOMFIELD, CT, 06002, US

(21) Appl. No.: 11/269,060

(22) Filed: Nov. 8, 2005

(51) Int. Cl. G06F 15/16

(52) U.S. Cl. 709/204

(57) ABSTRACT

Exemplary embodiments relate to methods, systems, and computer program products for providing a scheduler for multiple parties. Methods include receiving information indicating requested attendees and a duration for a meeting from a requestor. A storage device containing available time slots and meeting preferences for the requested attendees is accessed. One or more meeting time slots are determined based on the duration, the available time slots and the meeting preferences. An overall match score for each of the meeting time slots is calculated using the meeting time slot and the meeting preferences as input. A list including the meeting time slots and the associated overall match scores is created. The list is transmitted to the requestor.

### BACKGROUND

Exemplary embodiments relate generally to a scheduler, and more particularly, to methods, systems and computer program products for providing a scheduler for multiple parties.

Application programs for providing calendaring functions are commercially available. However, these commercially available calendaring applications do not provide the ability to take user preferences for meeting times into account when scheduling a meeting between multiple parties. This may result in several attempts to schedule a meeting and may be particularly cumbersome when a large number of attendees are required to be invited. It would be desirable to be able to take the user preferences of requested meeting attendees into account when selecting a meeting time slot. Taking requested meeting attendees preferences into account before deciding on a meeting time slot would lead to fewer rejections of meeting invitations and therefore fewer attempts at re-scheduling the meeting.

In addition, current commercially available calendaring applications do not allow a meeting requestor to select a next best meeting time when one of the requested attendees rejects the meeting invitation. It would be desirable for a meeting requestor to be able to receive a list of possible meeting times (based for e.g., on requested attendee preferences) and to be able to order the list from first choice to last choice. Then, if one of the requested attendees rejects the meeting invitation, a new meeting invitation could be sent to the next best choice on the list.

### SUMMARY

Exemplary embodiments relate to methods, systems, and computer program products for providing a scheduler for multiple parties. Methods include receiving information indicating requested attendees and a duration for a meeting from a requestor. A storage device containing available time slots and meeting preferences for the requested attendees is accessed. One or more meeting time slots are determined based on the duration, the available time slots and the meeting preferences. An overall match score for each of the meeting time slots is calculated using the meeting time slot and the meeting preferences as input. A list including the meeting time slots and the associated overall match score for each of the meeting time slots is created. The list is transmitted to the requestor.

Systems for providing a scheduler for multiple parties include an input device, an output device and a processor in communication with the input and output devices. The input device receives information indicating requested attendees and a duration for a meeting from a requestor. The processor includes computer instructions for facilitating accessing a storage device containing available time slots and meeting preferences for the requested attendees. The computer instructions also facilitate determining one or more meeting time slots based on the duration, the available time slots and the meeting preferences. An overall match score for each of the meeting time slots is calculated using the meeting time slot and the meeting preferences as input. A list including the meeting time slots and the associated overall match score for each of the meeting time slots is created. The output device transmits the list to the requestor.

Computer program products for a scheduler for multiple parties include a storage medium readable by a processing circuit and storing instructions for execution by the processing circuit for facilitating a method. The method includes accessing information received from a requestor that indicates requested attendees and a duration for a meeting. A storage device containing available time slots and meeting preferences for the requested attendees is accessed. One or more meeting time slots are determined based on the duration, the available time slots and the meeting preferences. An overall match score for each of the meeting time slots is calculated using the meeting time slot and the meeting preferences as input. A list including the meeting time slots and the associated overall match score for each of the time slots is created. The transmission of the list to the requestor is initiated.

Methods for providing a scheduler for multiple parties also include transmitting information indicating requested attendees and a duration for a meeting from a requestor to a scheduler. The scheduler includes computer instructions to facilitate accessing a storage device containing available time slots and meeting preferences for the requested attendees. The scheduler also includes computer instructions to facilitate: determining one or more meeting time slots responsive to the duration, to the available time slots and to the meeting preferences; calculating an overall match score for each of the meeting time slots, the calculating responsive to the meeting time slot and to the meeting preferences; creating a list including the meeting time slots and the associated overall match score for each of the time slots; and transmitting the list. The list from the scheduler is received by the requestor.

Other systems, methods, and/or computer program products according to exemplary embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Referring now to the drawings wherein like elements are numbered alike in the several FIGURES:

FIG. 1 is a flow diagram of an exemplary process for providing a scheduler for multiple parties;

FIG. 2 is a flow diagram of an exemplary process for handling a rejection of a meeting invitation; and

FIG. 3 is a block diagram of a system that may be utilized to provide a scheduler for multiple parties.

### DETAILED DESCRIPTION OF EXEMPLARY EMBODIMENTS

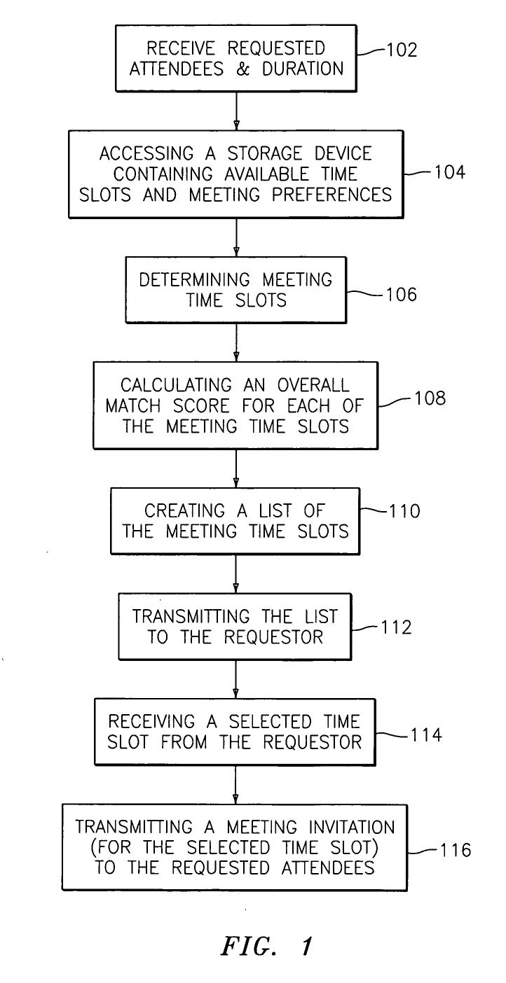

FIG. 1 is a flow diagram of an exemplary process for providing a scheduler for multiple parties in accordance with exemplary embodiments. At block 102 the scheduler receives the requested attendees and a duration (e.g., hours, minutes) for a meeting to be scheduled. The requested attendees may specify user names, computer identifications or other means of uniquely identifying the requested attendee. A meeting refers to any type of gathering of the requested attendees such as, but not limited to: conference room meetings, seminars, lunches, outings, etc. The requestor may also specify that the meeting should be held within a particular time frame (e.g., within the week and within the month).

At block 104, the scheduler accesses a storage device that contains available time slots and meeting preferences for the requested attendees. The available time slots may be broken down into increments such as, but not limited to, fifteen minute time intervals, half hour time intervals or one hour time intervals. The storage device also contains meeting preferences associated with each of the time slots for each of the requested attendees. In exemplary embodiments, the preferences include “open for meetings”, “prefer no meetings to be scheduled” and “absolutely no meetings to be scheduled.” These three preferences are intended to be examples only and other preferences may also be implemented by exemplary embodiments. Other preferences may include, for example, preferred meeting location. The preferences may be sourced from a profile with instructions for individual users (e.g., requested attendees) such as, but not limited to: prefer not to have morning meetings, no meetings after four in the afternoon on Fridays, etc. The scheduler may insert the preferences into the storage device based on the instructions in the profile. Alternatively, or in addition, the individual users may directly enter their preferences for each time slot, or block of time slots. The scheduler may also be defaulted or pre-programmed not to schedule meetings on certain days such as weekends or holidays, defined after work hours, and/or during a lunch hour. The defaulted or pre-programmed time slots may be customized to accommodate varying requirements between implementations. For example, different companies and/or different locations of the same company may give employees the day off for different holidays.

At block 106, possible meeting time slots are determined by the scheduler in response to the duration, to the available time slots for the requested attendees and to the meeting preferences of the requested attendees. For example, a meeting requestor may request a meeting with a duration of one hour between users A, B and C. The scheduler may determine, by looking at the records in the storage device, that A, B and C have three one hour open time slots in common that last for the specified duration (one hour). In alternate exemplary embodiments, the determining may also be responsive to conference room availability and/or conference room resources (e.g., white boards and capacity of conference room). In further alternate exemplary embodiments, the determining is also responsive to the locations of the requested attendees as compared to the location of the meeting. In some cases, the travel time from the attendee location to the location of the meeting and back may be figured into the required number of time slots. In other cases, the location of one or more of the requested attendees may determine the location of the meeting.

At block 108, an overall match score for each of the meeting time slots is calculated. Continuing the above example, requested attendees A and B may have a preference of “open for meetings to be scheduled” by all three open time slots. Requested attendee C may have a preference of “open for meetings to be scheduled” by the first time slot, a preference of “prefer no meetings to be scheduled” by the second time slot, and a preference of “absolutely no meetings to be scheduled” by the third time slot.

In this case, the first meeting slot may be assigned an overall match score of 100%, the second meeting slot may be assigned an overall match score of 83%, and the third meeting slot may be assigned an overall match score of 67%. The values of the overall match score may depend on the weight assigned to each type of preference. In this example, the preference of “open for meetings to be scheduled” is assigned a weighting value of 1 for requested attendees A, B and C; a preference of “prefer no meetings to be scheduled” is assigned a value of 0.5 for requested attendee C and a preference of “absolutely no meetings to be scheduled” is assigned a value of 0 for requested attendee C. The overall match score for the first meeting slot is calculated by adding 1+1+1 and dividing the sum by 3 (because there are 3 requested attendees), resulting in an overall match score of 100%. The overall match score for the second meeting slot is calculated by adding 1+1+0.5 and dividing the sum by 3, resulting in an overall match score of approximately 83%. The overall match score for the third meeting slot is calculated by adding 1+1+0 and dividing the sum by 3, resulting in an overall match score of approximately 67%.

Alternate exemplary embodiments utilize different weights than those shown in the above example and the weights may be modified based on installation and/or requestor requirements. For example, a greater importance may be applied to requested attendee A being able to attend (e.g., attendee A may be a key participant in the meeting and/or the manager of the meeting requestor) than to requested attendee C being able to attend (e.g. attendee C may be an optional participant and/or a subordinate of the meeting requestor). This difference in importance may be reflected in the weights given to the preferences of requested attendees A and C. The weights associated with the preferences for the requested attendees may be manipulated by the requestor and applied to only the current meeting being scheduled, to meetings relating to a particular subject and/or to all meetings scheduled by the requestor. In exemplary embodiments, the weights for all requested attendees are the same and therefore not taken into account in calculating the overall match score.

At block 110, a list of the meeting time slots is created. In exemplary embodiments, the list is ordered from the meeting time slot with the highest overall match score to the meeting time slot with the lowest overall match score. In the above example, the order of the list would be: the first meeting time slot (overall match score of 100%), the second meeting time slot (overall match score of 83%), the third meeting time slot (overall match score of 67%). In alternate exemplary embodiments, the list is not ordered but includes an indicator of the overall match score next to each meeting time slot. In other alternate exemplary embodiments, the list is ordered by meeting time slot date with an indicator of the overall match score indicated next to each meeting time slot.

At block 112, the list is transmitted to the meeting requestor. In exemplary embodiments, in response to receiving the list, the requestor may reorder the list by sending instructions to the scheduler. In response to the reordering instructions, the scheduler then reorders the list based on the instructions from the requestor. In exemplary embodiments the list transmitted to the requestor also includes the overall match score corresponding to each of the meeting time slots on the list. In exemplary embodiments, in response to receiving the list, the meeting requester requests from the scheduler an individual match score (or other details such as individual preferences) for one or more of the requested attendees for one of the meeting time slots on the list. The requestor may request more detail by selecting a details option and one or more of the requested attendees on a user interface screen. The scheduler then calculates the individual match score for the selected requested attendees and transmits them to the requestor. In the example described previously, if the meeting time slot was the second time slot on the list and the requestor requested the individual match score for all three of the requested attendees, the request would result in the scheduler transmitting an individual match score of 100% for requested attendees A and B, and an individual match score of 50% for requested attendee C. The requestor could also request the preferences associated with the meeting time slot for one or more of the requested attendees. In response to this request, the scheduler transmits the preferences associated with the meeting time slot for one or more of the requested attendees to the requestor.

Once the meeting requester receives the list and determines which of the meeting time slots to select for the meeting, the requestor transmits instructions to the scheduler to send out a meeting invitation to the requested attendees. The instructions also include one of the meeting time slots on the list for the invitation to specify. At block 114, the scheduler receives the selected time slot and request to set up a meeting from the requestor. When the scheduler receives the instructions from the requestor to send out a meeting invitation for the selected time slot, it performs the step depicted in block 116, transmitting the meeting invitation to the requested attendees. In exemplary embodiments, the meeting requestor may be notified when all of the requested attendees (or some subset specified by the meeting requestor) have accepted the meeting invitation.

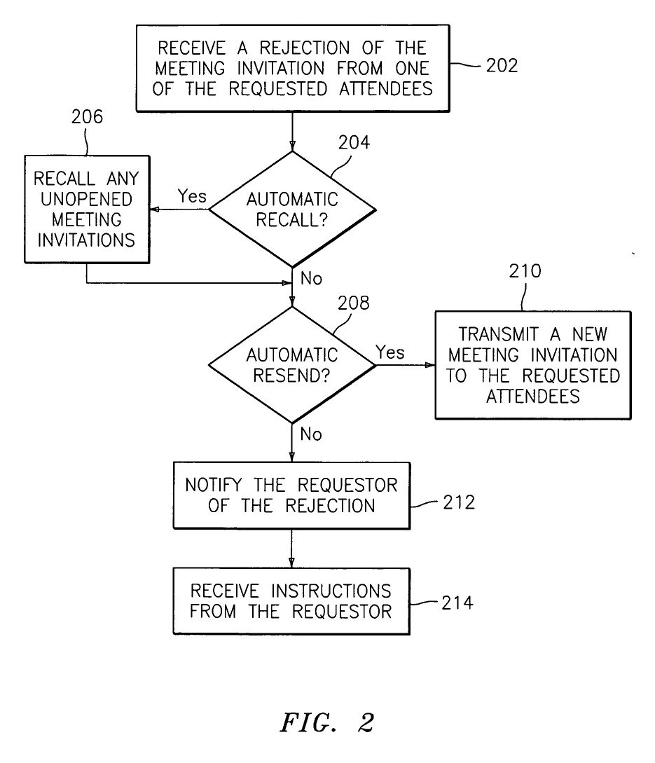

In exemplary embodiments, one or more of the requested attendees may reject the meeting invitation. FIG. 2 is a flow diagram of an exemplary process for handling a rejection of a meeting invitation. At block 202, a rejection of the meeting is received from one of the requested attendees. At block 204, it is determined if an automatic recall function has been enabled. If it has been enabled, then upon receiving the rejection, processing continues at block 206. At block 206, the scheduler automatically recalls any unopened meeting invitations from the requested attendees. In exemplary embodiments, the scheduler also removes the meeting from the schedule(s) of requested attendees that have already accepted the meeting invitation. Processing then continues at block 208.

At block 208, it is determined if automatic resend is being utilized. If automatic resend is being utilized, then processing continues at block 210. At block 210, upon receiving a rejection of the meeting invitation from one of the requested meeting attendees, the scheduler automatically transmits a second meeting invitation to the requested attendees. In exemplary embodiments, the scheduler selects the next meeting time slot on the list for the meeting time slot in the second meeting invitation. For example, if the rejected meeting invitation specified a meeting time slot in the second position on the list, then the next meeting invitation would specify a meeting time slot in the third position on the list. As described previously, the order of the list may be the original order created by the scheduler, or alternatively, the list may have been reordered by the requester. In exemplary embodiments, the scheduler may automatically transmit the second meeting invitation only if specified criteria are met (e.g., the requested attendee that is rejecting the meeting has been specified by the requestor as a mandatory attendee).

Alternatively, if automatic resend is not being utilized, then processing continues at block 212. At block 212, the scheduler notifies the meeting requestor of the rejection. At block 214, the scheduler receives instructions from the meeting requestor. The requestor may decide to reschedule the meeting. In response the scheduler may ask the meeting requestor for a second meeting time slot and perform steps 114 and 116 from FIG. 1 for the second meeting time slot. Alternatively, the requestor may determine, based on the importance of the requested attendee rejecting the meeting invitation, whether or not to attempt to reschedule the meeting.

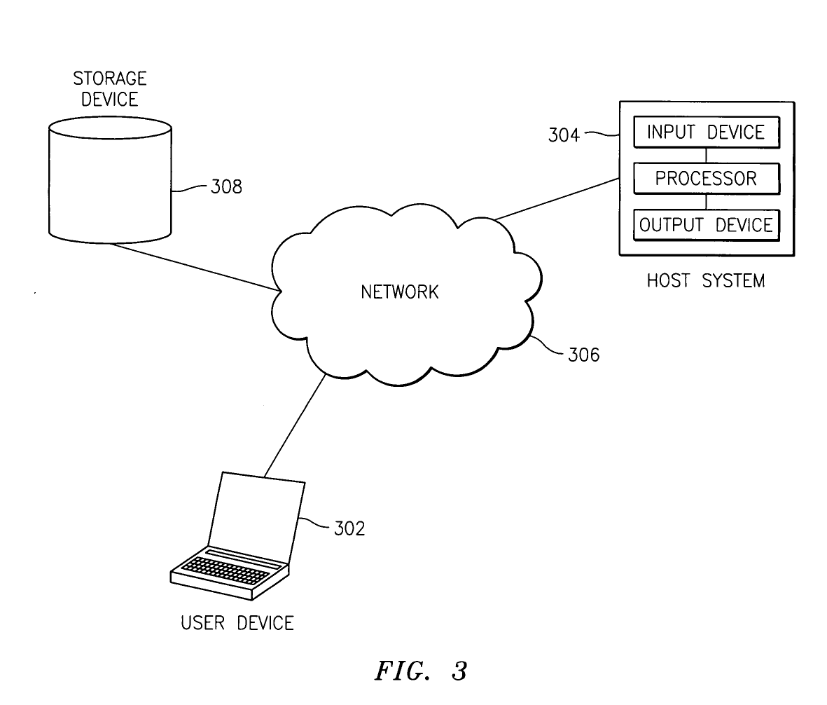

FIG. 3 is a block diagram of a system that may be utilized to provide a scheduler for multiple parties in accordance with exemplary embodiments. The system includes one or more user devices 302 through which requestors at one or more geographic locations may contact the host system 304 to access the scheduler application (referred to herein as the “scheduler”). In exemplary embodiments of the present invention, the host system 304 executes the scheduler application to perform the functions described herein. The scheduler may be implemented by software and/or hardware components. In alternate exemplary embodiments, the scheduler described herein is built on top of an existing calendaring program or system (e.g., Microsoft Outlook). In exemplary embodiments, the user devices 302 are coupled to the host system 304 via a network 306. Each user device 302 may be implemented using a general-purpose computer executing a computer program for carrying out the processes described herein. The user devices 302 may be personal computers, lap top computers, personal digital assistants, cellular telephones, host attached terminals, etc. with user interfaces for communicating with the scheduler. The user interfaces may be implemented by interface screens, audio technology, voice recognition technology, or any other technology to allow the meeting requester to communicate with the scheduler. If the user devices 302 are personal computers (or include the required functionality), the processing described herein may be shared by a user device 302 and the host system 304 (e.g., by providing an applet to the user device 302) or contained completely within one or more of the user devices 302.

The network 306 may be any type of known network including, but not limited to, a wide area network (WAN), a local area network (LAN), a global network (e.g. Internet), a virtual private network (VPN), and an intranet. The network 306 may be implemented using a wireless network or any kind of physical network implementation. A user device 302 may be coupled to the host system 304 through multiple networks (e.g., intranet and Internet) so that not all user devices 302 are coupled to the host system 304 through the same network. One or more of the user devices 302 and the host system 304 may be connected to the network 306 in a wireless fashion.

The storage device 308 may be implemented using a variety of devices for storing electronic information. It is understood that the storage device 308 may be implemented using memory contained in the host system 304 or the user device 302 or it may be a separate physical device. The storage device 308 is logically addressable as a consolidated data source across a distributed environment that includes a network 306. Information stored in the storage device 308 may be retrieved and manipulated via the host system 304. The storage device 308 includes data such as the available time slots, the meeting preferences for the requested attendees and optionally, weights to be assigned to the preferences of the requested attendees. In exemplary embodiments, the storage device includes a database for users (potential meeting requesters and potential requested attendees) of the scheduler system. Each record in the database may include a unique user identifier, an open time slot identifier, and a preference associated with the open time slot time slot. Portions or all of the records may be located on electronic business cards such as VCards. These electronic business cards may be utilized to implement all or portions of the storage device 308. The storage device 308 may also include other kinds of data such as information concerning the priorities and weights to be given to particular requested attendees. In exemplary embodiments, the host system 304 operates as a database server and coordinates access to application data including data stored on storage device 308.

The host system 304 depicted in FIG. 1 may be implemented using one or more servers operating in response to a computer program stored in a storage medium accessible by the server. The host system 304 may operate as a network server (e.g., a web server) to communicate with the user device 302. The host system 304 handles sending and receiving information to and from the user device 302 and can perform associated tasks. The host system 304 may also include a firewall to prevent unauthorized access to the host system 304 and enforce any limitations on authorized access. For instance, an administrator may have access to the entire system and have authority to modify portions of the system. A firewall may be implemented using conventional hardware and/or software.

The host system 304 may also operate as an application server. The processor in the host system 304 executes one or more computer programs to implement the scheduler. Processing may be shared by the user device 302 and the host system 304 by providing an application (e.g., java applet) to the user device 302. Alternatively, the user device 302 may include a stand-alone software application for performing a portion or all of the processing described herein. As previously described, it is understood that separate servers may be utilized to implement the network server functions and the application server functions. Alternatively, the network server, the firewall, and the application server may be implemented by a single server executing computer programs to perform the requisite functions. The input device in the host system 304 may be implemented by a receiver for receiving data over the network 306 or via the user device 302. The output device in the host system 304 may be implemented by a transmitter for transmitting data over the network 306 or to the user device 302. Alternatively, the input device and/or output device may be implemented by reading from and writing to a storage location on the host system 304 and/or the storage device 308.

As described above, the scheduler may be utilized to scheduler meetings between multiple parties. The scheduler may be utilized to prioritize possible meeting time slots based on preferences associated with the requested attendees and on requested attendee importance to the meeting, and to automatically reschedule a meeting if a meeting attendee rejects the invitation. In addition, conference room availability and location may be factored in to scheduling the meeting. Utilizing embodiments of the scheduler may allow a meeting requestor to scheduler a multiple party meeting in less time resulting in an increase in user satisfaction and a lower cost.

As described above, embodiments may be in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims.

What is claimed is:

1. A method for providing a scheduler for multiple parties, the method comprising:
receiving information indicating requested attendees and a duration for a meeting from a requestor;
accessing a storage device containing available time slots and meeting preferences for the requested attendees;
determining one or more meeting time slots, the determining responsive to the duration, to the available time slots and to the meeting preferences;
calculating an overall match score for each of the meeting time slots, the calculating responsive to the meeting time slot and to the meeting preferences;
creating a list including the meeting time slots, the list indicating the overall match score for each of the meeting time slots; and
transmitting the list to the requestor.

2. The method of claim 1 further comprising:
receiving instructions to reorder the list from the requestor; and
reordering the list based on the instructions.

3. The method of claim 1 further comprising:
receiving instructions from the requestor to send out a meeting invitation for a first meeting time slot selected from the meeting time slots on the list; and
transmitting the meeting invitation to the requested attendees.

4. The method of claim 3 further comprising:
receiving a rejection of the meeting invitation from one of the requested attendees;
notifying the requestor of the rejection;
receiving instructions from the requestor to send out a second meeting invitation for a second meeting time slot selected from the meeting time slots on the list; and
transmitting the second meeting invitation to the requested attendees.

5. The method of claim 3 further comprising:
receiving a rejection of the meeting invitation from one of the requested attendees; and
automatically transmitting a second meeting invitation in response to receiving the rejection, wherein the second meeting invitation is transmitted to the requested attendees for a second meeting time slot selected from the meeting time slots on the list and the second meeting time slot is next on the list from the first meeting time slot.

6. The method of claim 3 further comprising:
receiving a rejection of the meeting invitation from one of the requested attendees; and
automatically recalling any unopened meeting invitations from the requested attendees in response to receiving the rejection.

7. The method of claim 3 further comprising notifying the requestor when all of the requested attendees have accepted the meeting invitation.

8. The method of claim 1 wherein the meeting preferences for each of the available time slots for each of the requested attendees indicate one of open for meetings to be schedule, prefer no meetings to be scheduled and absolutely no meetings to be scheduled.

9. The method of claim 1 further comprising receiving weights to be assigned to the meeting preferences of one or more of the requested attendees, wherein the calculating is further responsive to the weights.

10. The method of claim 1 wherein the list further includes the overall match score corresponding to each of the meeting time slots.

11. The method of claim 1 further comprising:
receiving a request from the requestor for an individual match score for one or more of the requested attendees for one of the meeting time slots on the list;
calculating the individual match score for each of the one or more of the requested attendees, the individual match score responsive to the meeting time slot and to meeting preferences associated with the meeting time slot for the requested attendee; and
transmitting the individual match score for each of the one or more of the requested attendees to the requester.

12. The method of claim 1 further comprising transmitting the meeting preferences associated with the meeting time slot for one or more of the requested attendees to the requestor.

13. The method of claim 1 wherein the determining is further responsive to one or more of conference room availability and conference room resources.

14. The method of claim 1 wherein the determining is further responsive to locations of the requested attendees.

15. A system for providing a scheduler for multiple parties, the system comprising:
an input device for receiving information indicating requested attendees and a duration for a meeting from a requestor;
a processor in communication with the input device including computer instructions for facilitating:
accessing a storage device containing available time slots and meeting preferences for the requested attendees;
determining one or more meeting time slots, the determining responsive to the duration, to the available time slots and to the meeting preferences;
calculating an overall match score for each of the meeting time slots, the calculating responsive to the meeting time slot and to the meeting preferences; and
creating a list including the meeting time slots, the list indicating the overall match score for each of the meeting time slots; and
an output device in communication with the processor for transmitting the list to the requestor.

16. The system of claim 15 wherein the input device and the output device are in communication with a network for receiving the information indicating the requested attendees and the duration from the requester and for transmitting the list to the requestor.

17. The system of claim 15 wherein one or more of audio and voice recognition technology are utilized to perform one or more of the receiving the information indicating the requested attendees and the duration from the requester and the transmitting the list to the requestor.

18. A computer program product for providing a scheduler for multiple parties, the computer program product comprising:
a storage medium readable by a processing circuit and storing instructions for execution by the processing circuit for facilitating a method comprising:
accessing information from a requestor indicating requested attendees and a duration for a meeting;
accessing a storage device containing available time slots and meeting preferences for the requested attendees;
determining one or more meeting time slots, the determining responsive to the duration, to the available time slots and to the meeting preferences;
calculating an overall match score for each of the meeting time slots, the calculating responsive to the meeting time slot and to the meeting preferences;
creating a list including the meeting time slots, the list indicating the overall match score for each of the meeting time slots; and
initiating the transmission of the list to the requester.

19. The computer program product of claim 18 wherein the method further comprises:
receiving instructions from the requestor to send out a meeting invitation for a first meeting time slot selected from the meeting time slots on the list;
transmitting the meeting invitation to the requested attendees.
receiving a rejection of the meeting invitation from one of the requested attendees; and
automatically transmitting a second meeting invitation in response to receiving the rejection, wherein the second meeting invitation is transmitted to the requested attendees for a second meeting time slot selected from the meeting time slots on the list and the second meeting time slot is next on the list from the first meeting time slot.
